(19) United States
(12) Patent Application Publication
(10) Pub. No.: US 2025/0184088 A1
(43) Pub. Date: Jun. 5, 2025

(54) VARIABLE CONFIGURATIONS FOR ARTIFICIAL INTELLIGENCE CHANNEL STATE FEEDBACK WITH A COMMON BACKBONE AND MULTI-BRANCH FRONT-END AND BACK-END

(71) Applicant: QUALCOMM Incorporated, San Diego, CA (US)

(72) Inventors: Chenxi HAO, Beijing (CN); June NAMGOONG, San Diego, CA (US); Taesang YOO, San Diego, CA (US); Abdelrahman Mohamed Ahmed Mohamed IBRAHIM, San Diego, CA (US); Jay Kumar SUNDARARAJAN, San Diego, CA (US); Pavan Kumar VITTHALADEVUNI, San Diego, CA (US); Yu ZHANG, San Diego, CA (US)

(21) Appl. No.: 18/876,150

(22) PCT Filed: Aug. 12, 2022
(86) PCT No.: PCT/CN2022/111981

§ 371 Date: Dec. 17, 2024

(51) Int. Cl. H04L 5/00

(52) U.S. Cl. CPC H04L 5/0053; H04L 5/0048

(57) ABSTRACT

An apparatus, method and computer-readable media are disclosed for providing a general structure for supporting various configurations such as various antenna configurations and subband configurations. For example, a process may include receiving a channel state information (CSI) report configuration comprising at least one of a CSI reporting subband pattern configuration, an antenna configuration, a restriction on possible ranks to be reported, or a payload configuration. The process may include determining, based on the CSI report configuration, a CSI report dimension associated with output of a machine learning model used by a user equipment to generate a CSI report. The process may further include generating the CSI report using the machine learning model based on the CSI report dimension.

### CROSS-REFERENCE TO RELATED APPLICATIONS

This application for Patent is a 371 of international Patent Application PCT/CN2022/111981, filed Aug. 12, 2022, which is hereby incorporated by referenced in its entirety and for all purposes.

### FIELD

The present disclosure generally relates to machine learning (ML) systems for wireless communications. For example, aspects of the present disclosure relate to systems and techniques for providing a general structure for supporting various configurations such as various antenna configurations and subband configurations. The general structure can include a machine learning based encoder deployed on a user equipment (UE) and a machine learning based decoder deployed at a network device or node (e.g., a base station such as a gNodeB (gNB) or portion thereof) and which include a front-end multi-branch layer and a back-end multi-branch layer for handling various configurations.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML based algorithms may be incorporated into the 5G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for training a machine learning model that includes a front-end multi-branch layer that receives antenna setup or an antenna setup group and determines a selected branch of a plurality of branches in the front-end multi-branch layer for performing a linear embedding or a transformation of the input from a first domain such as a transmission domain to a second domain such as a feature domain to generate a first output. The model can be deployed as an encoder on a UE or as a decoder on a network device or node (e.g., a base station such as a gNodeB (gNB) or portion thereof.

A common backbone of the machine learning model may receive the first output and extract deep features with positional encoding to generate a second output and a back-end multi-branch layer of the machine learning model uses a selected branch based on one or more of a subband configuration, a rank, an antenna configuration (which can include the antenna setup or the antenna setup group) or a payload configuration. The selected branch compresses the second output to generate a latent message having a dimension for transmission to a receive device such as a base station or gNB.

In one illustrative example, an apparatus for wireless communication is provided that includes at least one memory storing instructions to operate a machine learning model trained to support channel state information (CSI) report with at least one of variable antenna configurations, variable subband configurations, variable ranks, or variable payload configurations. The apparatus further includes at least one processor coupled to the at least one memory and configured to: obtain an input to a front-end multi-branch layer of the machine learning model; process the input via a selected branch of a plurality of branches in the front-end multi-branch layer to generate a first output; process the first output by a common backbone of the machine learning model to yield a second output; provide the second output to a back-end multi-branch layer of the machine learning model; and process the second output via a selected branch of a plurality of branches of the back-end multi-branch layer to generate a latent message have a dimension.

In another illustrative example, a method for wireless communication is provided that includes: obtaining an input to a front-end multi-branch layer of a machine learning model trained to support channel state information (CSI) report with at least one of variable antenna configurations, variable subband configurations, variable ranks, or variable payload configurations; processing the input via a selected branch of a plurality of branches in the front-end multi-branch layer to generate a first output; processing the first output by a common backbone of the machine learning model to yield a second output; providing the second output to a back-end multi-branch layer of the machine learning model; and processing the second output via a selected branch of a plurality of branches of the back-end multi-branch layer to generate a latent message have a dimension.

In another illustrative example, a non-transitory computer-readable medium is provided that has instructions, that when executed by one or more processors, causes the one or more processors to: obtain an input to a front-end multi-branch layer of a machine learning model trained to support channel state information (CSI) report with at least one of variable antenna configurations, variable subband configurations, variable ranks, or variable payload configurations; process the input via a selected branch of a plurality of branches in the front-end multi-branch layer to generate a first output; process the first output by a common backbone of the machine learning model to yield a second output; provide the second output to a back-end multi-branch layer of the machine learning model; and process the second output via a selected branch of a plurality of branches of the back-end multi-branch layer to generate a latent message have a dimension.

In another illustrative example, an apparatus for wireless communication is provided that includes: means for obtaining an input to a front-end multi-branch layer of a machine learning model trained to support channel state information (CSI) report with at least one of variable antenna configurations, variable subband configurations, variable ranks, or variable payload configurations; means for processing the input via a selected branch of a plurality of branches in the front-end multi-branch layer to generate a first output; means for processing the first output by a common backbone of the machine learning model to yield a second output; means for providing the second output to a back-end multi-branch layer of the machine learning model; and means for processing the second output via a selected branch of a plurality of branches of the back-end multi-branch layer to generate a latent message have a dimension.

In another illustrative example, an apparatus for wireless communication is provided that includes: a machine learning model trained to support at least one of variable antenna configurations, variable subband configurations, variable ranks or variable payload configurations; a front-end multi-branch layer of the machine learning model; a common backbone of the machine learning model; a back-end multi-branch layer of the machine learning model; at least one memory storing instructions to operate the machine learning model; and at least one processor coupled to the at least one memory. The at least one processor is configured to: receive an input to the front-end multi-branch layer of the machine learning model; process the input via a selected branch of a plurality of branches in the front-end multi-branch layer to generate a first output; process the first output by the common backbone of the machine learning model to yield a second output; provide the second output to the back-end multi-branch layer of the machine learning model; process the second output via a selected branch of a plurality of branches of the back-end multi-branch layer to generate a latent message have a dimension; and transmit the latent message having the dimension to a communication device via a wireless interface.

In another illustrative example, a method for wireless communication is provided that includes: receiving an input to a front-end multi-branch layer of a machine learning model trained to support at least one of variable antenna configurations, variable subband configurations, variable ranks or variable payload configurations; processing the input via a selected branch of a plurality of branches in the front-end multi-branch layer to generate a first output; processing the first output by the common backbone of the machine learning model to yield a second output; providing the second output to a back-end multi-branch layer of the machine learning model; processing the second output via a selected branch of a plurality of branches of the back-end multi-branch layer to generate a latent message have a dimension; and transmitting the latent message having the dimension to a communication device via a wireless interface.

In another illustrative example, a non-transitory computer-readable medium is provided that has instructions, that when executed by one or more processors, causes the one or more processors to: receive an input to a front-end multi-branch layer of a machine learning model trained to support at least one of variable antenna configurations, variable subband configurations, variable ranks or variable payload configurations; process the input via a selected branch of a plurality of branches in the front-end multi-branch layer to generate a first output; process the first output by the common backbone of the machine learning model to yield a second output; provide the second output to a back-end multi-branch layer of the machine learning model; process the second output via a selected branch of a plurality of branches of the back-end multi-branch layer to generate a latent message have a dimension; and transmit the latent message having the dimension to a communication device via a wireless interface.

In another illustrative example, an apparatus for wireless communication is provided that includes: means for receiving an input to a front-end multi-branch layer of a machine learning model trained to support at least one of variable antenna configurations, variable subband configurations, variable ranks or variable payload configurations; means for processing the input via a selected branch of a plurality of branches in the front-end multi-branch layer to generate a first output; means for processing the first output by the common backbone of the machine learning model to yield a second output; means for providing the second output to a back-end multi-branch layer of the machine learning model; means for processing the second output via a selected branch of a plurality of branches of the back-end multi-branch layer to generate a latent message have a dimension; and means for transmitting the latent message having the dimension to a communication device via a wireless interface.

In another illustrative example, an apparatus for wireless communication is provided that incudes at least one memory and at least one processor coupled to the at least one memory and configured to: receive a channel state information (CSI) report configuration comprising at least one of a CSI reporting subband pattern configuration, an antenna configuration, a restriction on possible ranks to be reported, or a payload configuration; determine, based on the CSI report configuration, a CSI report dimension associated with output of a machine learning model used by a user equipment to generate a CSI report; and generate the CSI report using the machine learning model based on the CSI report dimension.

In another illustrative example, a method for wireless communication is provided that incudes: receiving a channel state information (CSI) report configuration comprising at least one of a CSI reporting subband pattern configuration, an antenna configuration, a restriction on possible ranks to be reported, or a payload configuration; determining, based on the CSI report configuration, a CSI report dimension associated with output of a machine learning model used by a user equipment to generate a CSI report; and generating the CSI report using the machine learning model based on the CSI report dimension.

In another illustrative example, a non-transitory computer-readable medium is provided that has instructions, that when executed by one or more processors, causes the one or more processors to: receive a channel state information (CSI) report configuration comprising at least one of a CSI reporting subband pattern configuration, an antenna configuration, a restriction on possible ranks to be reported, or a payload configuration; determine, based on the CSI report configuration, a CSI report dimension associated with output of a machine learning model used by a user equipment to generate a CSI report; and generate the CSI report using the machine learning model based on the CSI report dimension.

In another illustrative example, an apparatus for wireless communication is provided that includes: means for receiving a channel state information (CSI) report configuration comprising at least one of a CSI reporting subband pattern configuration, an antenna configuration, a restriction on possible ranks to be reported, or a payload configuration; means for determining, based on the CSI report configuration, a CSI report dimension associated with output of a machine learning model used by a user equipment to generate a CSI report; and means for generating the CSI report using the machine learning model based on the CSI report dimension.

In another illustrative example, an apparatus for wireless communication is provided that includes at least one memory storing instructions to operate a machine learning model trained to support channel state information (CSI) report with at least one of variable antenna configurations, variable subband configurations, variable ranks, or variable payload configurations. The apparatus further includes at least one processor coupled to the at least one memory and configured to: obtain an input to a front-end multi-branch layer of the machine learning model; process the input via a selected branch of a plurality of branches in the front-end multi-branch layer to generate a first output; process the first output by a common backbone of the machine learning model to yield a second output; and generate, based on the second output, a latent message have a dimension.

In another illustrative example, a method for wireless communication is provided that includes: obtaining an input to a front-end multi-branch layer of a machine learning model trained to support channel state information (CSI) report with at least one of variable antenna configurations, variable subband configurations, variable ranks, or variable payload configurations; processing the input via a selected branch of a plurality of branches in the front-end multi-branch layer to generate a first output; processing the first output by a common backbone of the machine learning model to yield a second output; and generating, based on the second output, a latent message have a dimension.

In another illustrative example, a non-transitory computer-readable medium is provided that has instructions, that when executed by one or more processors, causes the one or more processors to: obtain an input to a front-end multi-branch layer of a machine learning model trained to support channel state information (CSI) report with at least one of variable antenna configurations, variable subband configurations, variable ranks, or variable payload configurations; process the input via a selected branch of a plurality of branches in the front-end multi-branch layer to generate a first output; process the first output by a common backbone of the machine learning model to yield a second output; and generate, based on the second output, a latent message have a dimension.

In another illustrative example, an apparatus for wireless communication is provided that includes: means for obtaining an input to a front-end multi-branch layer of a machine learning model trained to support channel state information (CSI) report with at least one of variable antenna configurations, variable subband configurations, variable ranks, or variable payload configurations; means for processing the input via a selected branch of a plurality of branches in the front-end multi-branch layer to generate a first output; means for processing the first output by a common backbone of the machine learning model to yield a second output; and means for generating, based on the second output, a latent message have a dimension.

In another illustrative example, an apparatus for wireless communication is provided that includes at least one memory storing instructions to operate a machine learning model trained to support channel state information (CSI) report with at least one of variable antenna configurations, variable subband configurations, variable ranks, or variable payload configurations. The apparatus further includes at least one processor coupled to the at least one memory and configured to: process an input to a common backbone of the machine learning model to yield an output; provide the output to a back-end multi-branch layer of the machine learning model; process the output via a selected branch of a plurality of branches of the back-end multi-branch layer to generate a latent message have a dimension.

In another illustrative example, a method for wireless communication is provided that includes: processing an input to a common backbone of a machine learning model to yield an output, wherein the machine learning model is trained to support channel state information (CSI) report with at least one of variable antenna configurations, variable subband configurations, variable ranks, or variable payload configurations; providing the output to a back-end multi-branch layer of the machine learning model; and processing the output via a selected branch of a plurality of branches of the back-end multi-branch layer to generate a latent message have a dimension.

In another illustrative example, a non-transitory computer-readable medium is provided that has instructions, that when executed by one or more processors, causes the one or more processors to: process an input to a common backbone of a machine learning model to yield an output, wherein the machine learning model is trained to support channel state information (CSI) report with at least one of variable antenna configurations, variable subband configurations, variable ranks, or variable payload configurations; provide the output to a back-end multi-branch layer of the machine learning model; and process the output via a selected branch of a plurality of branches of the back-end multi-branch layer to generate a latent message have a dimension.

In another illustrative example, an apparatus for wireless communication is provided that includes: means for processing an input to a common backbone of a machine learning model to yield an output, wherein the machine learning model is trained to support channel state information (CSI) report with at least one of variable antenna configurations, variable subband configurations, variable ranks, or variable payload configurations; means for providing the output to a back-end multi-branch layer of the machine learning model; and means for processing the output via a selected branch of a plurality of branches of the back-end multi-branch layer to generate a latent message have a dimension.

A non-transitory computer-readable storage medium comprising instructions stored thereon which, when executed by at least one processor, causes the at least one processor to perform operations according to any of the processes, methods or operations disclosed herein.

An apparatus for wireless communications comprising one or more means for performing operations according to any of the processes, methods or operations disclosed herein.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIG. 7A illustrates a block diagram showing an encoder encoding input to generate a latent message transmitted to a decoder at a gNB that generate an output based on the latent message, in accordance with aspects of the present disclosure;

FIG. 7B illustrates a block diagram associated with an encoder on a user equipment having a common backbone and a front-end multi-branch layer and a back-end multi-branch layer for generating a latent message having a dimension, in accordance with aspects of the present disclosure;

FIG. 7C illustrates a block diagram associated with a decoder on a gNB having a common backbone and a front-end multi-branch layer and a back-end multi-branch layer for receiving and decompressing the latent message having the dimension, in accordance with aspects of the present disclosure;

FIGS. 8A-8B illustrate flow diagrams associated with different aspects of a machine learning model having a common backbone and a front-end multi-branch layer and a back-end multi-branch layer, in accordance with aspects of the present disclosure; and

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various techniques are provided in reference with wireless technologies (e.g., The 3^{rd} Generation Partnership Project (3GPP) 5G/New Radio (NR) Standard) to provide improvements to wireless communications. The present disclosure focuses on a machine learning model that can be implemented as an encoder on a UE and a decoder on a network device and which includes a front-end multi-branch layer and a back-end multi-branch layer which enable the machine learning model to support variable antenna configurations, variable subband configurations or variable rank or variable payload configurations.

Additional aspects of the present disclosure are described in more detail below with respect to the figures.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station may be referred to as an uplink (UL) channel (e.g., a reverse traffic channel, a reverse control channel, an access channel, etc.). A communication link through which the base station may send signals to UEs may be referred to as a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

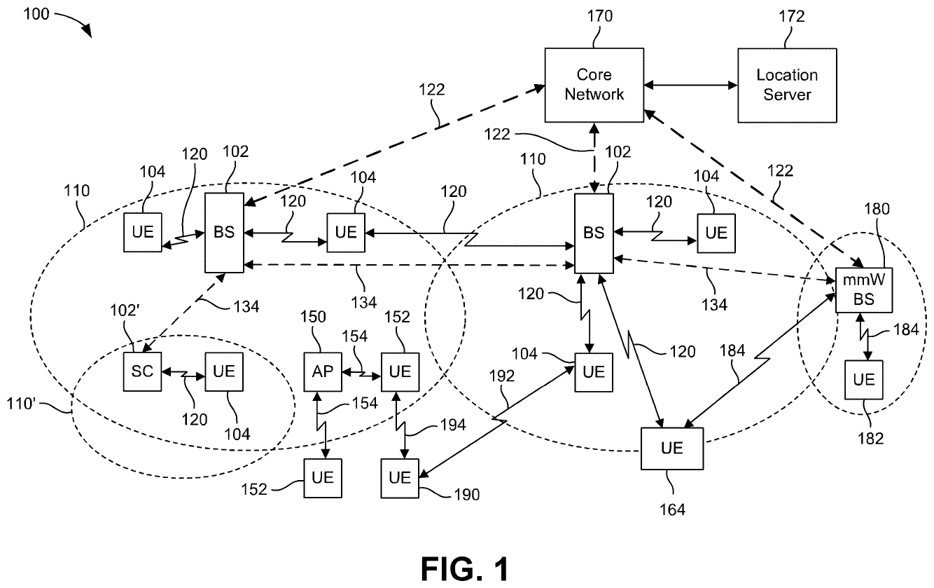

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” may require to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

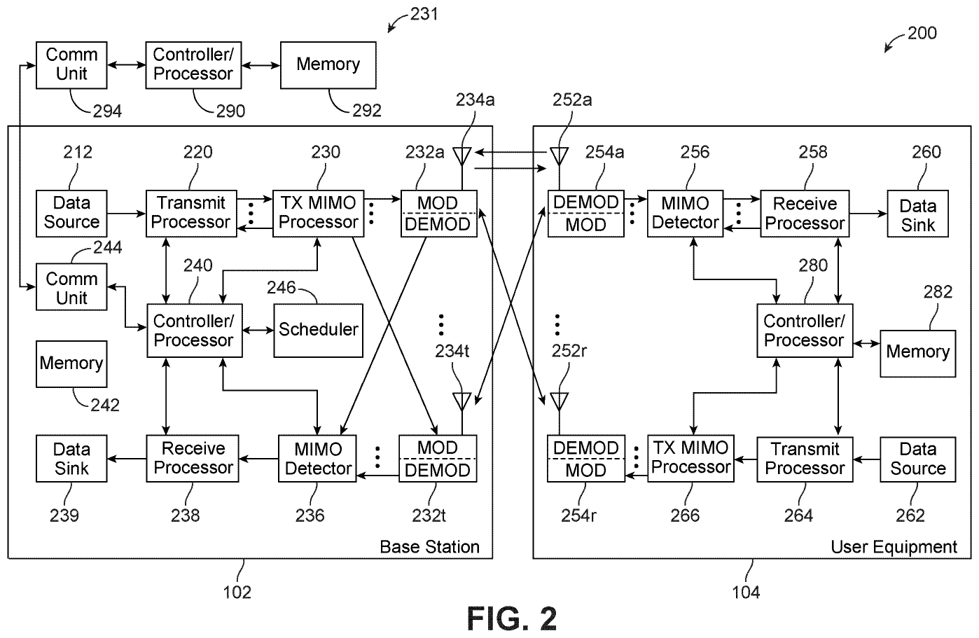

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G/New Radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

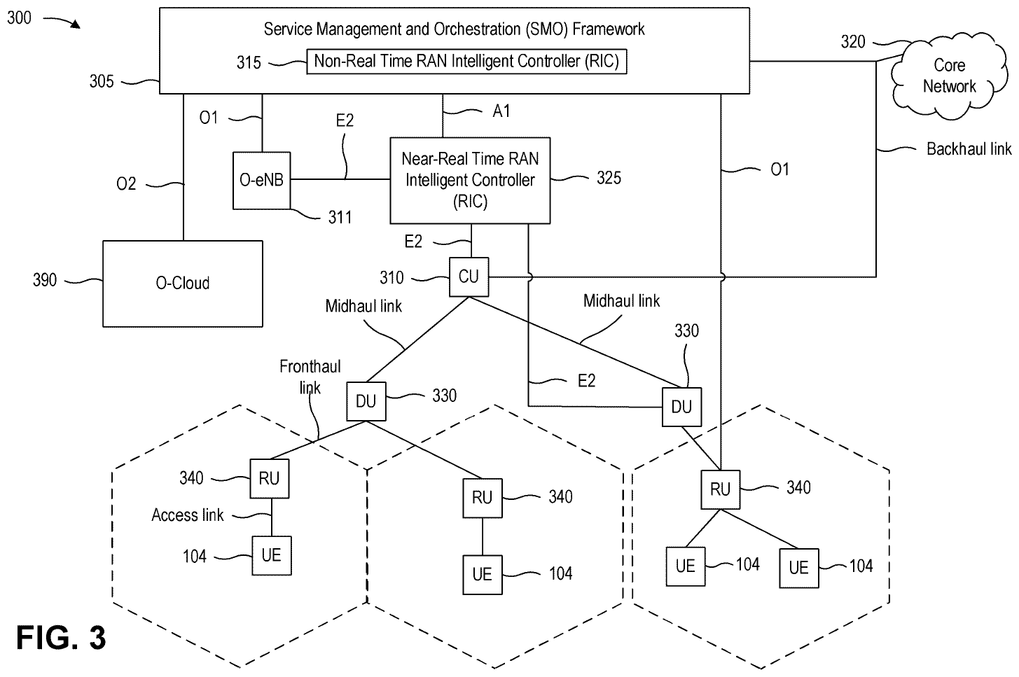

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

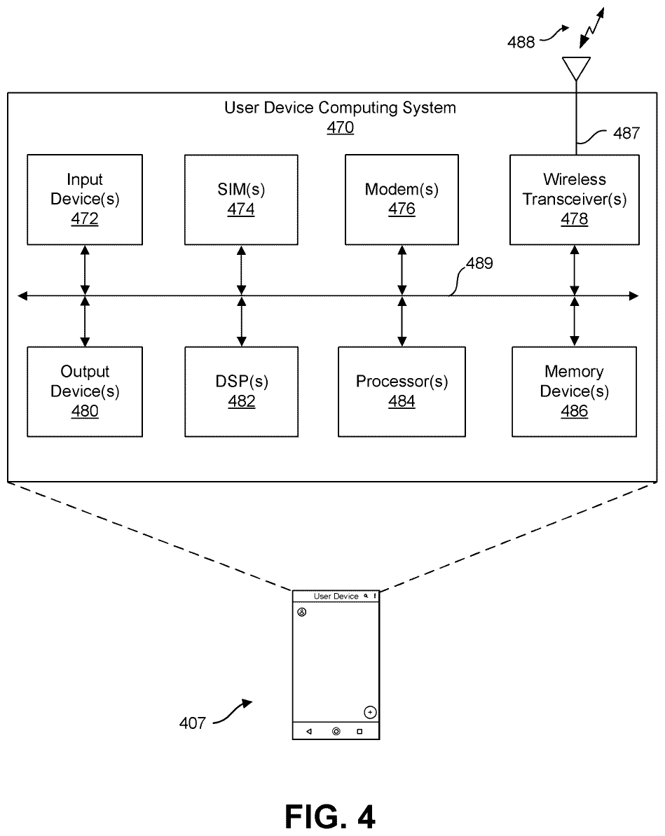

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

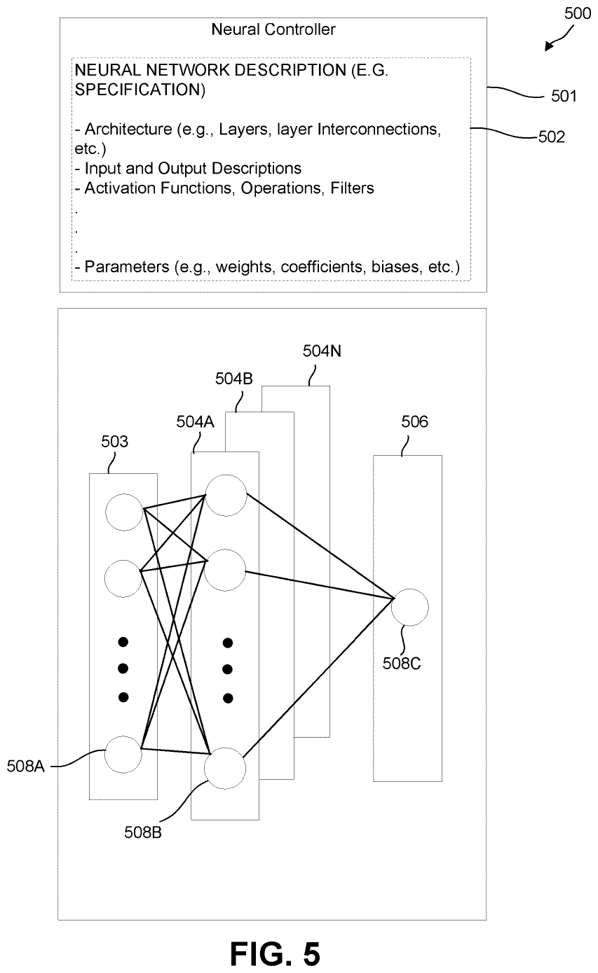

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

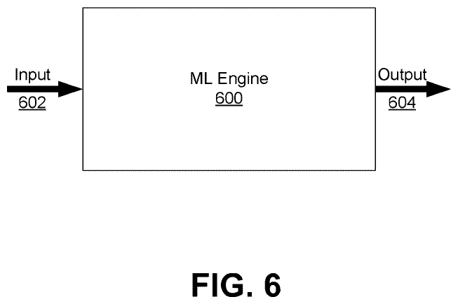

Increasingly ML (e.g., AI) algorithms (e.g., models) are being incorporated into a variety of technologies including wireless telecommunications standards. FIG. 6 is a block diagram illustrating an ML engine 600 which can be trained as part of the framework disclosed herein in order to provide the ability to support at least one of variable antenna configurations, variable subband configurations, variable ranks and variable payload confirmations. As an example, one or more devices in a wireless system may include ML engine 600. In some cases, ML engine 600 may be similar to neural network 500. In this example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on, such as making predictions, based on variable data, regarding which branch of a multi-branch front-end layer to the ML engine 600 to use for linear embedding. As an example, an ML engine 600 configured to determine how to process variable data, may receive as input 602, data regarding one or more of an antenna configuration of a network entity, a subband configuration from the network entity, a rank or a payload configuration, etc. In some cases, the output 604 may be predictions or other information generated by the ML engine 600 and the output 604 may be used to configure a wireless device, select a particular branch for processing data at either a front-end or a back-end of an encoder or decoder. Continuing the previous examples, the ML engine 600 configured as described herein can determine for example a dimension for a latent message based on at least one of an antenna configuration of a network entity, a subband configuration from the network entity, a rank or a payload configuration. Similarly, the ML engine 600 configured as disclosed herein may determine which branch of a back-end multi-branch layer to use based on a number of dimensions associated with a latent message or other data provided to an encoder. The latent message can be the channel state information (CSI) reporting payload or the CSI that is compressed as described herein and transmitted from a UE to a network entity. The processes and framework also work for a front-end multi-branch layer of a decoder and a back-end multi-branch layer of a decoder in a mirror fashion to the encoder.

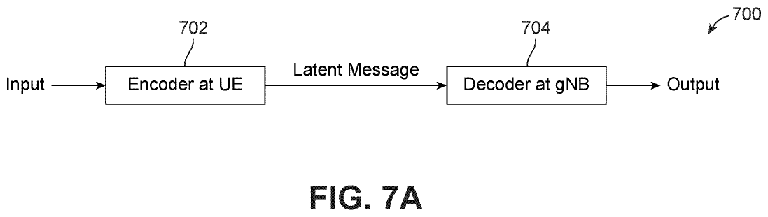

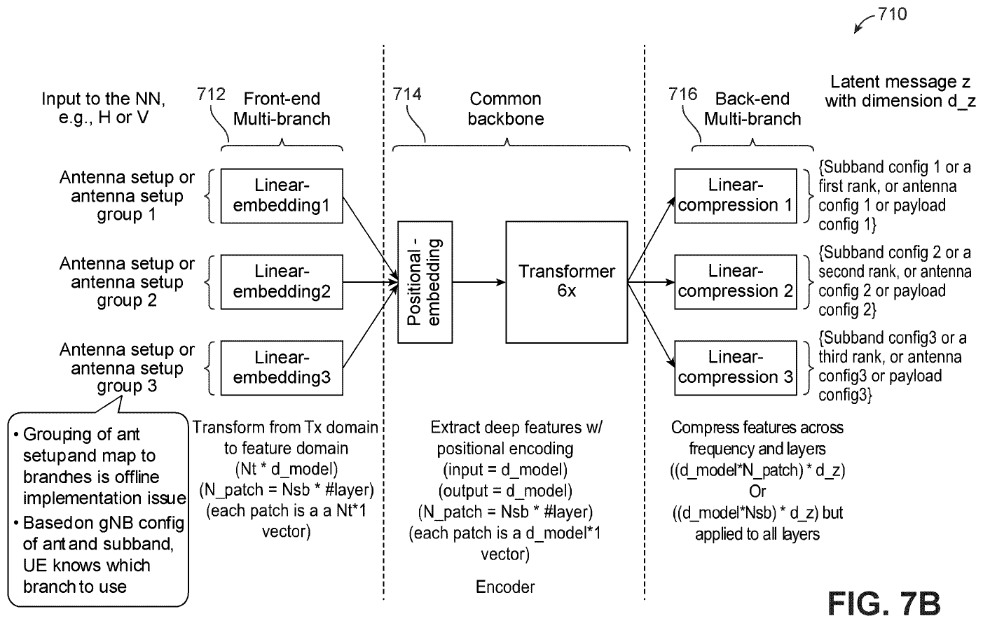

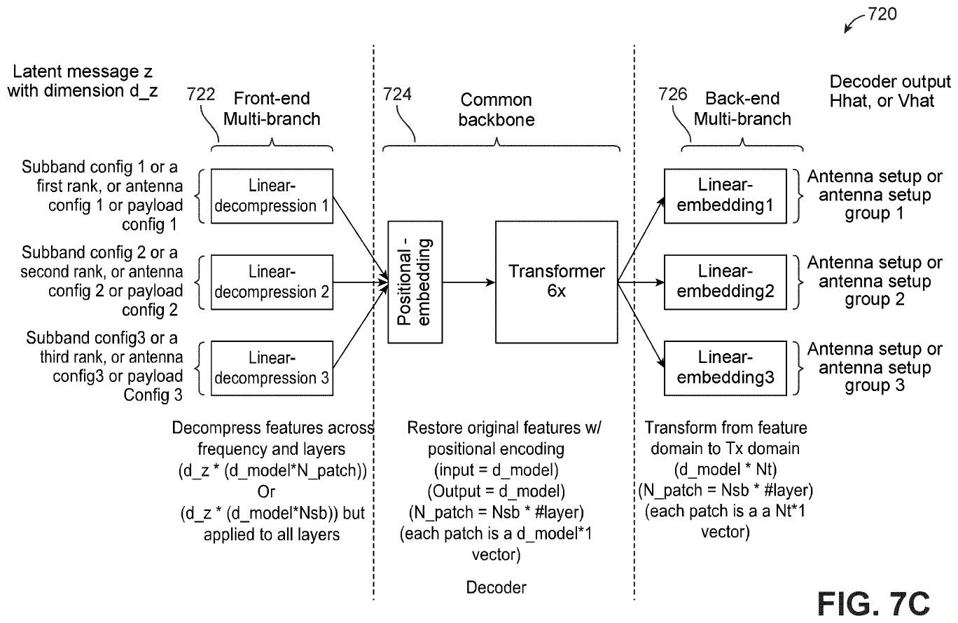

FIGS. 7A-7C illustrate various aspects of implementing a common backbone with a front-end and a back-end to support variable antenna configurations, variable subband configurations, variable ranks and variable payload configurations. In some aspects, a two-sided artificial intelligence or machine learning AI/ML model has been adopted as a representative use case. Normally, the AI/ML model is trained for a particular configuration in terms of antenna port configuration, subband configuration and payload configuration. However, in some cases, variable antenna config and subband configs are supported for features such as, for example, channel state information. In one example, there are 13 antenna configurations and arbitrary subband pattern up to 19 subbands. What is needed is a new framework for supporting these variable configs. This discloser provides a general structure to support variable configurations. The general framework can include an AI/ML model having a common backbone (e.g., via a transformer or other AI/ML or neural network (NN) model). The general framework can use multiple parallel branches in a front-end and in a back-end as well to support variable configurations. A first family in the front-end is used to support variable antenna configurations, while a second family of branches at the back-end can be used to handle multiple subband configurations, payload configurations or variable ranks. In terms of signaling, the UE may report supported antenna configs and subband configs as UE may only implement a reasonable number of branches in its general framework.

In terms of reporting dimension, the framework may scale with number of subbands or subband spans. For a larger number of antenna ports, the UE may support high, medium and low dimension. For small number of antenna ports, the UE may support low dimension. For variable rank, higher dimension is considered for low rank while lower dimension is considered for high rank to maintain similar payload as low rank.

The data that is communicated through the general framework described herein can be any type of data. However, one particular example of the type of data that can be processed is channel state information feedback (CSI feedback or CSF). The CSI report configuration in wireless protocols can include a codebook, which is used as a precoding matrix indicator (PMI) dictionary from which the UE would generate a report of the best PMI codeword that can describe the PMI, and use a sequence of bits to report the PMI. The gNB receives the sequence of bits it will look up which PMI codeword is reported.

A brief discussion of CSF or channel states information (CSI) follows. A UE may report CSI to a base station using one of two types of spatial information feedback: Type I CSI feedback and Type II CSI feedback. Type I CSI feedback is a CSI feedback scheme that comprises codebook-based precoding matrix indicator (PMI) feedback with normal spatial resolution in beamforming, while Type II CSI feedback is an enhanced CSI feedback scheme that enables codebook-based feedback with higher spatial resolution in beamforming than Type I CSI feedback. Although Type II CSI feedback only allows a UE to report a rank indication (RI) of at most 2, this feedback scheme can provide higher throughput through improved beamforming and resource allocation than Type I CSI feedback by bringing more beamforming gain and separating users with higher granularity. Thus, Type II CSI feedback may be useful for multiple-user-multiple-input-multiple-output (MU-MIMO) deployment scenarios, for scenarios where the signal may be scattered (e.g., multipath), for situations where interference by other UEs may require highly granular beamforming directed toward the UE, for UE located at cell edges, etc.

However, the complexity for a UE in computing PMI for a Type II codebook may be significantly higher than that of a Type I codebook. While PMI for Type I CSI feedback is generally computed based on a single beam, PMI for Type II CSI feedback is generally computed based on the weighted sum of multiple discrete Fourier transform (DFT) beams, the value of which is comprised of the summation of the products of different wideband amplitudes, subband amplitudes, and cophasing for each beam over a number of beams L. Such CSI feedback uses significant computational power of the UE. Moreover, Type II CSI feedback may have a large overhead compared to Type I CSI feedback, since a UE using Type II CSI feedback must report the indices of L DFT beams for each layer, polarization, and beam, as well as the wideband amplitude scale, subband amplitude scale, and cophasing for each beam to the base station. With such a relatively large payload size, a UE may spend significant transmission power as well as computational power in reporting Type II CSI feedback to the base station. It can thus be challenging for a UE to determine the optimal parameters for precoding based on the size of the allowed codebook for Type II CSI feedback.

Thus, while Type II CSI feedback may be beneficial in situations where there are many other users or where the UE is at the cell edge, this feedback scheme may be less efficient in scenarios where higher spatial resolution may not be necessary. For example, Type II CSI feedback may have less performance gain in situations where the UE is located close to the base station, where there is not much interference by other UEs, or in single-user-multiple-input-multiple-output (SU-MIMO) deployments. In such cases, the gain may not outweigh the burdens of relatively large overhead and significant UE computational complexity. Hence, it would be desirable for UEs to be allowed to determine based on the channel condition whether to use a Type II codebook or to revert back to a Type I codebook when performing the CSI feedback procedure and PMI selection. Moreover, when a base station allocates uplink resources based on Type II CSI feedback for a UE to transmit precoding information in uplink control information (UCI), it would be desirable to allow the UE to signal Type I precoding information in a format that fits within the allocated resources (e.g. container) for Type II CSI feedback when the UE has determined to revert back to a Type I codebook. In Rel-16, enhanced Type II (eT2 or eType II) CSI feedback is introduced. Similar to Type II, the enhanced Type II codebook is also based on linear combination of spatial bases (DFT). The difference compared to Type II lies in frequency domain reduction and support of up to rank4. This enables eTpye II to report CSI with spatial and frequency compression more effectively, and eType II achieve higher throughput than Type II under same CSI reporting payload.

The approach disclosed herein provides an AI-based CSI feedback which can replace the PMI codebook by a CSI encoder and decoder. FIG. 7A illustrates a block diagram 700 including an encoder 702 at the UE that receives input, encodes the input and produces a latent message which is transmitted to a decoder on a gNB 704 to generate the output. The encoder 702 is analogous to the PMI searching algorithm (implementation issue) in the current system. The encoder input can be a downlink channel matrix (H), a downlink precoder vector (V), or an inference covariance matrix Rnn. The input can include a label or assistant information that is utilized in selecting a branch of a front-end multi-branch layer as described below. The decoder 704 can be analogous to or replace the PMI codebook which is used to translate the CSI reporting bits to a PMI codeword. The decoder 704 output could be: a downlink channel matrix (H); a raw vs. whitened downlink channel; transmit covariance matrix; a downlink precoder vector (V); a value SV which can be a precoder vector multiplied by an eigen value S; or an interference covariance matrix (Rnn). A whitened downlink channel is a channel where interference has been processed and removed using a filter at the UE. The H or the V could correspond to raw channel or channel pre-whitened by the UE based on its demodulation filter. In general, the output of the decoder 704 recovers the input into the encoder 702. The “latent message” can represent a compressed version of the encoder 702 input in whatever form and that is transmitted to the decoder 704 for decoding and to obtain the original input. In some cases, the output of the decoder 704 is the eigen-vector or downlink precoder V while the input to the encoder 702 is the channel (raw channel or whitened channel) H. In this case, the “latent message” can represent a compressed channel state information based on which the decoder 704 can obtain the desired output.

As introduced above, since the variability that can be addressed by the disclosed machine learning model includes variable subband configurations in the network, the following provides background on subband configurations.

In a first step, given the bandwidth part (BWP) bandwidth (BW), there are two possible total number of subbands dependent on two possible subband sizes. In one protocol, the smallest (total or maximum) number of subbands in one BWP is 3 and the highest (total or maximum) number of subbands in one BWP is 19. This is because BWP starting point can be an arbitrary resource block (RB), but subbands are counted from a common resource block (CRB) 0. For example, if a BWP={2, 3, . . . , 73} and a Sbsize=4, then SB1={2, 3}, SB2={4-7}, SB3={8-11}, . . . , SB18={68-71}, SB19={72, 73}. For PMI codebooks eType2, eType2-Port-Selection, Further enhanced Type2-Port-Selection, each subband can be further divided into two subbands for PMI. Table 1 shows various configuration subband sizes associated with a bandwidth part and an associated set of possible subband sizes.

TABLE 1

| Bandwidth part (PRBs) | Subband size (PRBs) |
|---|---|
| 24-72 | 4, 8 |
| 73-144 | 8, 16 |
| 145-275 | 16, 32 |

In a second step, a size-#SB bitmap is used to configure the subbands for which the CSI is reported. Based on the bitmap size, the UE can know the total number subbands in the BWP and the subband size. The actual #subbands can be 1-19. Based on the location of “1”s and “0”s in the bitmap, the UE knows the actual configured subbands. The actual subbands can be arbitrary pattern. In one example, a bitmap of subbands19 can indicate that there can be up to 19 subbands but because the bitmap can have both 1's and 0's, so the actual number of subbands can still range from 1 to 19 and can be contiguous or not contiguous.

In one example, in the RRC signaling CSI-reportingBand, the bitmap may show that there are 3 subbands via the bitmap subbands3, which can map to a bit string of size (3). In another example, the bitmap may show that there are 7 subbands via a bitmap subbands7 which can indicate to the UE that the bit string subband size can be size (7). The maximum number of subbands in one case can be from 3 to 19 inclusive, and each number of subbands identified in a bitmap can have a corresponding bit string subband size.

With respect to multiple antenna configurations, one protocol includes CSI codebooks where variable antenna configurations are supports. For example, table 2 shows in the left column a number of total ports that can be, for example, 4, 8, 12, 16, 24, 32. The right column can show the possible dual-polarization antenna configurations (N1, N2). The different numbers, such as (2, 1) or (4, 2) in the second column represent the number antenna or transceiver units (TXRUs) per dimension. Each TXRU has its own independent amplitude and phase control and is mapped to a group of physical antenna elements. The values N1, N2 represent how many TXRUs are configured in a first dimension for N1 and a second dimension for N2.

TABLE 2

| | |
|---|---|
| 4 | (2, 1) |
| 8 | (2, 2) |
| | (4, 1) |
| 12 | (3, 2) |
| | (6, 1) |
| 16 | (4, 2) |
| | (8, 1) |
| 24 | (4, 3) |
| | (6, 2) |
| | (12, 1) |
| 32 | (4, 4) |
| | (8, 2) |
| | (16, 1) |

For example, for an 8-port configuration, there can be a (2,2) dual polarization configuration or a (4, 1) dual polarization configuration. These variations can be handled by the common backbone disclosed herein.

The UE can generate a W1 matrix (v_{l,m}DFT vector below) used for spatial compression based on configured antenna setup (N1, N2) according to the following equations:

$${u}_{m} = \{ \begin{matrix}[ \begin{matrix}\begin{matrix}\begin{matrix}1 & {e}^{j \frac{2 π m}{{O}_{2} {N}_{2}}}\end{matrix} & …\end{matrix} & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

The W1 matrix is used for spatial compression. For example, the W1 matrix can convert a 32-port channel into, depending on its settings, into 8 dimensions (if there are 4 DFT beams configured and UE will select 4 DFT beams and apply them to both polarizations). The final PMI in Type I and Type II is W1*W2. W2 represents coefficients that combine the bases in W1. The final PMI in eType II is W1*W2*Wf where W2 is the coefficient matrix, Wf is the frequency compression.

The CSI compression is frequency-spatial compression of the eigen-vectors (e.g., 4 eigen vectors for 4 layers, each with 32×1 vector, 12 subband, so total 32*4*12). The legacy CSI approach can support variable Tx numbers (i.e, port numbers up to 32) and variable subband configs (up to 19 subbands with arbitrary pattern). For AI/ML-based CSF, the issue is how to support variable antenna configs, variable subband configs. For AI/ML-based CSF, the issue also is how to determine payload per variable configuration. For example, there might be a high or low payload for a high or low resolution of CSI compression. The configured payload can therefore also vary. The goal of this disclosure is to how to design and/or train one AI/ML model to handle variable configurations because a per-configuration training of different models is too complicated, would require too much memory, and require too many switches between models in practice. Thus, this disclosure provides for a single AI/ML model trained to handle the variable configurations disclosed herein.

FIG. 7B illustrates an encoder 710 having a front-end multi-branch layer 712 of a machine learning model, a common backbone 714 of the machine learning model and a back-end multi-branch layer 716 of the machine learning model. The input to the model or neural network can be, for example, a downlink channel matrix H or a downlink precoder V. The data can include, for example, data associated with a row from table 2 that indicates a number of ports and/or an antenna configuration or setup. There can also be groupings of different antenna configurations and the front-end multi-branch layer can be trained to map the antenna configuration or setup or other data in the input to a selected branch according to the antenna configuration or the group associated with the antenna configuration. The front-end multi-branch layer can be trained offline to perform this operation. Various training approaches are described below. The mapping can be based on a gNG configuration of antennas and subbands. The mapping can also relate to different antenna configurations or setups for different UEs from different vendors. Thus, the input data can relate to variable configurations for gNBs or variable configurations for UEs. Based on the input and/or assistant information or labels associated with the input, the UE can determine which branch to use of the front-end multi-branch layer. Each branch in the front-end multi-branch layer can perform a respective linear embedding on different branches which transforms the input data from a transmission domain to a feature domain or more generally from one domain to another domain.

As the UE interacts with different gNB's via wireless communication and moves from gtNB to gNB, or as the machine leaning model 710 is deployed on different UEs that have different configurations, the input can be channel measurement based on the CSI-RS, and the assistant information of the input can be a variable antenna configuration and/or antenna setup groups, the machine learning model 710 can receive the assistant information based on gNB configuration, determine which branch of the front-end multi-branch layer to use for linear embedding or performing a transformation of the input from one domain to another domain, which generates a first output. The first output is further processed by the positional embedding layer and another neural network as part of the common backbone 714 shown by way of example a transformer that processes the output data six times to generate a second output. Herein, the weights in the positional embedding layer to be used is also selected based on the subband and rank configuration. The second output is passed into one of the back-end multi-branch layer. The selected branch can be based on one or more of a subband configuration, a rank, an antenna configuration or a payload configuration. These branches are configured to compress features across frequency and layers and to generate the latent message that is transmitted over an air interface to a network entity having a corresponding or complementary decoder 720 as shown in FIG. 7C. The latent message as a dimension denoted as d_z which is discussed more fully below.

FIG. 7C illustrates the decoder 720 that includes a front-end multi-branch layer 722 that receives a latent message with a dimension d_z and determines which layer or branch of the multi-branch layer should process the latent message. The latent message can include assistant information or a label such as subband configuration information, a rank, an antenna configuration and/or a payload configuration. The assistant information or label enables the decoder to select which branch to use to process the latent message. Each branch of the front-end multi-branch layer of the machine learning model on the decoder 720 performs a different type or different aspect of linear decompression to decompress features across frequency and layers and provide an output to a positional embedding layer of a common backbone 724 of the machine learning model. The common backbone 724 restores the original features with positional encoding and processes the output of the positional embedding layer six times through a transformer. Herein, the weights in the positional embedding layer to be used is also selected based on the subband and rank configuration. The positional embedding layer shown in FIG. 7B as part of the common backbone 714 receives the output from the branch of the front-end multi-branch layer 712. The linear embedding is similar to the W1 matrix in that it transforms the input from the Tx domain to a feature domain which describes what happens in the neural network. The Nt*d_model is the dimension of each linear embedding layer of the front-end multi-branch layer 712. In one example, the d_model is a value selected as the dimension of the feature domain such as 256 and Nt can correspond to the number of ports and thus can have a value like 32. Each patch is Nt*1 vector. Each layer of the front-end multi-branch layer 712 transforms each patch from the Tx domain to feature domain based on these values.

The front-end multi-branch layer 712 can be, for example, a fully-connected neural network layer. The positional embedding approach ads some bias to its input. From the feature domain, which can be large, can include by way of example 48 patches (resulted by 12 subbands and 4 layers) in which each patch can have 256 values, the positional embedding stores the location of each patch. If there is an arbitrary subband configuration, the positional embedding can remember a location of the configured subband. Each patch (which can relate to a patch antenna) is a d_model*1 vector.

The use of a “transformer” as a machine learning model as part of the common backbone 714 and the number of times the data is processed as 6 times is exemplary only. The output of the common backbone 724 is provided to the back-end multi-branch layer 726 of the machine learning model in which different linear embedding processes are available to generate the antenna setup or antenna group setup output or to transform the data from the feature domain to the transmission domain and produce the decoder output Hhat or Vhat.

The latent message has a latent dimension d_z which depends on at least one of a subband pattern, an antenna configuration, a rank, and a payload configuration. The dimension d_z relates to the number of layers of the linear compression output. In one example, the output of the back-end multi-branch layer 716 has a value of (d_model*N_patch)*d_z applied to all spatial layers collectively. Here, for example, there can be 48 patches can be N_patch with d_model being 256 times the d_z value. This is very large liner compression layer apply to all the layers. Inside each layer of the back-end multi-branch layer 716. In another case, the linear layer compression layer size is (d_model*Nsb)*d_z applied to each spatial layer. Here Nsb means the number of subbands.

For example, with respect to the subband pattern, the d_z can scale with number of configured subbands, e.g., d_z=ceil(d_z_max*p), where p increases with Nsb, e.g., Nsb/19. Alternatively, d_z_1 can be applied to a 1′ set of Nsb, and d_z_2 can be applied to a 2^{nd} set of Nsb. In this case, d_z_1 can be greater than d_z_2 if Nsb_set1 great than the Nsb_set2. For example, d_z=32 is total number of subband <=6, while d_z=64 if total number of subbands >6 but <=12.

In another aspect, d_z can scale with subband span, i.e., d_z=ceil(d_z_max*p), where p increases with a subband span defined by (sb_max−sb_min), e.g., (sb_max−sb_min)/19 wherein sb_max and sb_min are respectively the highest subband index and the least subband index. Each d_z value may be implemented by a particular linear compression layer at the back-end multi-branch layer 716 of the encoder 710 or at the front-end multi-branch layer 722 of the decoder 720.

Subband configurations with a same d_z value can use the same linear compression layer at the back-end multi-branch layer 716 of the encoder 710 or the front-end multi-branch layer 722 of the decoder 720. A grouping of different or similar d_z values can occur such that the same linear compression layer 716 in the encoder (or the decompression layer 722 in the decoder) process all the d_z values in the grouping. For example, all subband patterns having <=6 subbands or subband span are grouped and use a first linear compression layer with d_z=32 in the back-end multi-branch layer, while all subband patterns having >6 subbands or subband spans are grouped and use a second linear compression layer with d_z=64.

In training phase, the data are labeled with their respective subband configuration, antenna configuration, rank or payload configuration. The data that can share same linear compression layer or linear embedding layer are grouped use the respective layer in the training. In some other cases, the training of the machine learning model can cause the common backbone 714 to generate not only a label but also may provide output, a dimension d_z or a group number which will cause the output of the common backbone 714 to be compressed by a particular branch of the back-end multi-branch layer 716.

With respect to the payload configuration and the antenna configuration, multiple d_z_max values (e.g., d_z_max1>d_z_max2>d_z_max3, etc) may be pre-defined in a standard or reported by the UE as additional capability. In one aspect, whether some or all of the d_z maximum values are applied can depend on the payload configuration and/or the antenna configuration. The UE can report multiple d_z_max values, such as one for a high payload, a second value for a medium payload and a third value for a low payload. For example, the UE can report its capabilities to a network entity such as supported antenna configurations, or a limited number of front-end multi-branch layer 712 branches that are support. The UE can support multiple antenna configurations per branch and report that data to the network entity. The UE may also report supported subband patterns such as the number of subbands, the number of subband spans or the range between the smallest subband index and the highest subband index and whether the subbands are contiguous or not. The same logic can apply to the actual reporting dimension d_z. That is, multiple d_z values are supported by the machine learning model, while all of the dimension values or subset of it depends on the antenna configurations. For example, the actual reporting dimension is resulted by d_z=ceil(d_z_max*p) where p depends on the subband configuration and d_z_max is determined per antenna configuration. By determining the allowed d_z_max per antenna configuration, the allowed d_z values are determined.

In one example, when the total #antenna ports is greater than or equal to a threshold 1 (e.g., 32 ports), the UE may support all d_z_max values. In another example, when the total #antenna ports is less than the threshold 1, but greater than or equal to a threshold 2, then the UE may support a first subset of d_z_max except for the largest d_z_max, e.g., (d_z_max2, d_z_max3).

In another example, when the total #antenna ports is less than the threshold 2, the UE may support a 2^{nd} subset of d_z_max wherein the 2^{nd} subset is a subset of 1^{st} set except for the second largest d_z_max, e.g., d_z_max3. Each d_z_max value may be implemented by a particular linear compression layer at the back-end multi-branch layer 716 of the encoder 710 or the front-end multi-branch layer 722 of the decoder 720.

Antenna configurations with a same d_z value may use the same linear compression layer at the back-end multi-branch layer 716 of the encoder 710 or the front-end multi-branch layer 722 of the decoder 720.

Different antenna configuration or an antenna configuration group may use different linear embedding at the front-end multi-branch layer 712 of the encoder or the back-end multi-branch layer of the decoder 726.

With respect to rank, a first d_z_max_set1={d_z_max1_1, d_z_max2_1, d_z_max3_1) can be applied to (each layer) rank 1 and 2. In another example, a second d_z_max_set2={d_z_max1_2, d_z_max2_2, d_z_max3_2) can be applied to (each layer) rank 3 and 4. Alternatively, a second d_z_max_set2 can be for rank3, and a third d_z_max_set3 is for rank4. In yet another example, the dimension for rank 3 and 4 can be comparable to rank 2, e.g., d_z_max1_2=d_z_max1_1*½, or d_z_max1_2=d_z_max1_1*⅔, d_z_max1_3=d_z_max1_1*½. A first set of linear compression layers (corresponding d_z_max_set1) can be applied for each spatial layer of rank 1 and 2. A second set of linear compression layers (corresponding to d_z_max2) can be applied to each spatial layer of rank3 or rank3+rank4. The same logic can apply to the actual reporting dimension d_z. That is, multiple d_z value sets are supported by the machine learning model, while larger dimension value set is supported for lower rank (e.g., rank 1 and 2) and smaller dimension value set is supported for higher rank (e.g., rank 3 and 4). For example, the actual reporting dimension is resulted by d_z=ceil(d_z_max*p) where p depends on the subband configuration and d_z_max is determined per rank hypothesis. By determining the allowed d_z_max per rank hypothesis, the allowed d_z values are determined.

In order to align or train the machine learning model on the supported antenna and/or subband configurations, various options can be applied. In a first option related to an offline training alignment context, a centralized training approach can include one entity such as a server associated with a UE vendor, a server associated with a network node or gNB vendor, or a third-party training server, can train the models (e.g., the encoder 710 and the decoder 720) and deliver the respective model to each UE and network node. In this approach, the UE vendor exposes its neural network or model architecture to the training entity and gives input sample and ground truth to the training entity. The data (sample, ground-truth) includes variable supported antenna/subband/payload config and includes variable rank hypothesis. The UE may also provide the corresponding antenna/subband/payload config and rank hypothesis for each provided data as label or assistant information.

Another approach is distributed training in which training at a network entity server and a UE serer occurs concurrently. In this approach, neither party exposes model architecture with each other but exchange data that can be used to train the respective models. In this manner, the UE server and the network server share data at each iteration of the training process. The UE server gives the ground-truth (target) and activations (between the encoder and decoder) to the network entity server. For each iteration, the pair data {target, activation} should include variable supported antenna/subband/payload configuration and includes variable rank hypothesis. The UE may also provide the corresponding antenna/subband/payload config and rank hypothesis for each provided data as label or assistant information. The network entity server provides the backward gradient to the UE server. In distributing training approach, an encoder for deployment on UEs and a decoder for deployment on one or more network entities such as gNBs can be trained without exposing proprietary data from either party.

In a separated training approach, the UE server trains its encoder first, and gives the latent message (z) and ground-truth or desired decoder output (v or vhat) to the network entity server for the network entity server to train the decoder. The pair data {z, v} or {z, vhat} can include variable supported antenna/subband/payload configurations and can include a variable rank hypothesis. The UE may also provide the corresponding antenna/subband/payload config and rank hypothesis for each provided pair data {z, v} or {z, vhat} as label or assistant information.

In some aspects, in some or all of the training approaches above, to train the neural network with a common backbone and a multi-branch structure, the following can be in the data set generation: (1) For subband configuration generalization, generate N>=1 random patterns (either contiguous or non-contiguous) for each data sample in the training set. The full subband pattern can be used in addition in some cases; and/or (2) For antenna configuration generalization, mix data sample generated based on M antenna configuration with equal proportion.

In one example, for a variable antenna configuration, the UE, the UE vendor or training entity (e.g., a server owned by the UE vendor or other vendor) may train the AI/ML model using mixed data set of 2×8 antenna configuration and 2×4 antenna configuration with equal proportion. In one example, for each sample in the training set, the training entity, UE vendor, or UE may generate random subband patterns in addition to the full subband case (assuming total 12 subbands). Arbitrary patterns may also be considered, such as randomly select N3 subbands from total 12 subbands where N3 ranging between 3 and 11. In another example, contiguous patterns may be considered and the number of subbands may be randomly generated between 3 and 12. In this case, if Nsb>6, an encoder output dimension=64 can be considered, while 32 is considered if Nsb<=6. In another example, discontiguous patterns may be considered and the number of subbands are randomly generated between 3 and 12. In this case, if Nsb>6, encoder output dimension=64 may be considered, while 32 is considered if Nsb<=6. For all of these configurations, the UE may generate N random patterns per data sample, where N may depend on the number of epochs. For centralized and distributed training, each random pattern may be generated per epoch; for separate training, the N random patterns may be generated after UE vendor-side training is done and N different versions of latent message z are to be provided to the gNB vendor side.

In another option, the UE can be capable of signaling reporting, for each model ID. After a model is trained, tested, complied, its ID will be registered at the radio access network meaning that a gNB can configure the model ID for the UE to use. The respective UE may download the corresponding complied run-time image from a model server. The UE can report supported antenna configuration to the gNB in that it may only support for example a limited number of front-end branches in the front-end multi-branch layer 712. The UE may support multiple antenna configurations per branch. In another aspect, the UE may report supported subband patterns such as the number of subbands supported, the number of subband spans which is the range between the smallest subband index and the highest subband index and whether the pattern is contiguous or not.

The machine learning models described herein can also be trained in a number of different ways such as on full subband cases with a d_z=64 and a d_z=32, or based on contiguous subband masks with Nsb=[3, 12], d_z=64 if Nsb>6 else d_z=32. In another example, the models can be trained on arbitrary subband masks with Nsb[3, 12], d_z=64 if Nsb>6 else d_z=32.

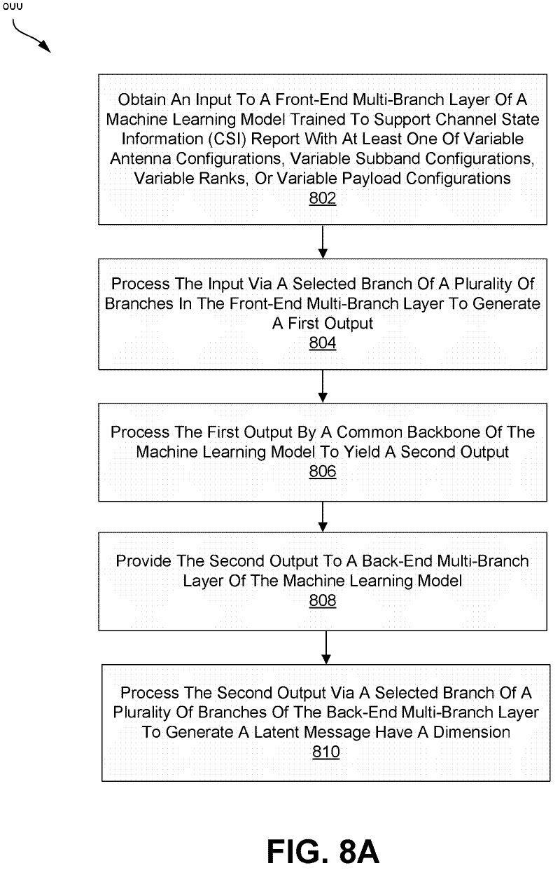

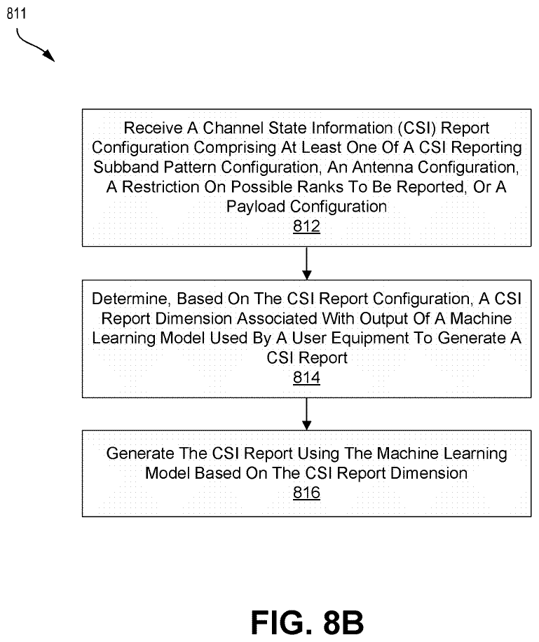

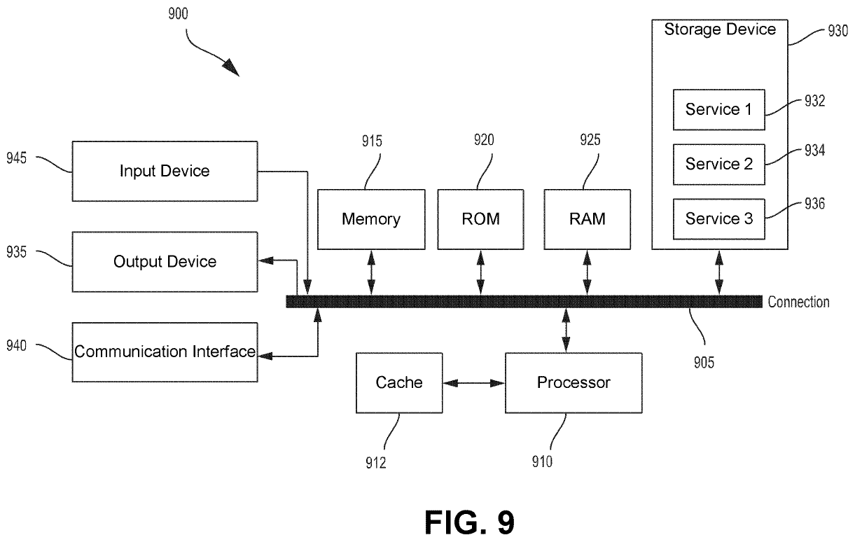

FIG. 8A is a flow chart illustrating an example of a process 800 for wireless communications utilizing reference signals for joint communication and sensing. The process 800 can be performed by a network device or by a component or system (e.g., a chipset) of the network device. The network device may include a UE (e.g., a mobile device such as a mobile phone, a network-connected watch, an extended reality (XR) device such as a virtual reality (VR) device or augmented reality (AR) device, a vehicle or computing device or system of the vehicle, or other device), a base station (e.g., an eNB, gNB, or other base station), a portion of the base station (e.g., a CU, DU, RU, or other portion of the base station), or other device. The operations of the process 800 may be implemented as software components that are executed and run on one or more processors (e.g., processor 910 of FIG. 9 or other processor(s)). Further, the transmission and reception of signals by the wireless communications device in the process 800 may be enabled, for example, by one or more antennas and/or one or more transceivers (e.g., wireless transceiver(s)).

At block 802, the network device (or component thereof) may obtain an input to a front-end multi-branch layer of a machine learning model trained to support channel state information (CSI) report with at least one of variable antenna configurations, variable subband configurations, variable ranks, or variable payload configurations. One illustrative example of the machine learning model is shown in FIG. 7B.

At block 804, the network device (or component thereof) may process the input via a selected branch of a plurality of branches in the front-end multi-branch layer to generate a first output.

At block 806, the network device (or component thereof) may process the first output by a common backbone of the machine learning model to yield a second output.

At block 808, the network device (or component thereof) may provide the second output to a back-end multi-branch layer of the machine learning model.

At block 810, the network device (or component thereof) may process the second output via a selected branch of a plurality of branches of the back-end multi-branch layer to generate a latent message have a dimension.

In some aspects, the back-end multi-branch layer includes a plurality of linear compression branches. For instance, as described above, each linear compression branch of the plurality of linear compression branches may be configured to compress the second output according to features across frequency and spatial layers.

In some cases, the dimension of the latent message is implemented by the selected branch of the back-end multi-branch of the machine learning model.

In some examples, different subband configurations with a same dimension for the latent message use a same compression layer associated with a respective branch of the plurality of branches of the back-end multi-branch layer.

In some aspects, the machine learning model is trained to group multiple antenna configurations into groups that are mapped to a respective branch of the plurality of branches in the front-end multi-branch layer.

In some cases, the variable antenna configurations are used by a base station to configure the CSI report associated to the machine learning model and wherein the variable subband configurations are the subbands associated with the CSI report.

In some examples, the dimension of the latent message is determined based on at least one of a subband pattern, an antenna configuration, a rank or a payload configuration associated with the input.

In some aspects, the machine learning model is trained to determine the dimension of the latent message based on the at least one of the subband pattern, the antenna configuration, the rank or the payload configuration associated with the input.

In some cases, the machine learning model is trained to group multiple subband configurations into groups that are mapped to a respective branch of the plurality of branches in the back-end multi-branch layer

In some examples, when the dimension of the latent message is determined based on the subband pattern, the dimension of the latent message scales with a number of configured subbands or scales with a subband span.

In some aspects, when the dimension of the latent message is determined based on the antenna configuration or the payload configuration the back-end multi-branch layer implements a maximum dimension value for the latent message at a respective compression layer associated with a respective branch of the back-end multi-branch layer.

In some cases, various antenna configurations that map to a same dimension value for the latent message use a same linear compression layer associate with a respective branch of the back-end multi-branch layer.

In some examples, when the dimension of the latent message is determined based on the rank, at least one of a first dimension set is applied to each layer associated with a respective branch of the back-end multi-branch layer for a first rank or a second rank and a second dimension set is applied to each layer associated with a respective branch of the back-end multi-branch layer for a third rank and a fourth rank.

In some aspects, the machine learning model is trained according to at least one of a centralized training approach, a distributed training approach, or a separated training approach.

In some cases, when the machine learning model is trained according to the centralized training approach, an entity associated with the apparatus exposes a machine learning model architecture to a training entity and provides an input sample and a ground truth to the training entity, wherein the input sample and the ground truth include at least one of variable supported antenna configurations, variable supported subband configurations, variable supported payload configurations, or variable rank hypothesis.

In some examples, when the machine learning model is trained according to the distributed training approach, an entity associated with the apparatus that communicates with a network entity, for each iteration of communicating training data, the entity associated with the apparatus provides a ground truth and an activation to the network entity, wherein the ground truth and the activation include at least one of variable supported antenna configurations, variable supported subband configurations, variable supported payload configurations or variable rank hypothesis.

In some aspects, when the machine learning model is trained according to the separated training approach, an entity associated with the apparatus trains an encoder first, and transmits a latent message and a ground truth or a desired decoder output to a network entity, wherein the latent message and the ground truth or the desired decoder output include at least one of variable supported antenna configurations, variable supported subband configurations, variable supported payload configurations or variable rank hypothesis.

In some cases, the apparatus only supports a limited number of branches in the front-end multi-branch layer.

In some aspects, the apparatus only supports certain subband patterns. In some cases, the certain subband patterns include one or more of a number of subbands, a number of subband spans, and whether the subbands are contiguous or not contiguous.

In some cases, the front-end multi-branch layer of the machine learning model utilizes antenna setup data in the input to select the selected branch of the plurality of branches of the front-end layer.

In some aspects, the front-end multi-branch layer of the machine learning model transforms the input from a transmission domain to a feature domain. In some cases, the common backbone of the machine learning model extracts deep features with positional encoding from the first output and to generate the second output.

In some cases, the common backbone of the machine learning model includes a positional embedding layer and a multi-layer machine learning layer.

In some examples, the back-end multi-branch layer of the machine learning model compresses features of the second output across frequency and layers to generate the latent message having the dimension.

In some aspects, each respective branch of the plurality of branches of the back-end multi-branch layer is associated with one or more of a respective subband configuration, a respective rank, a respective antenna configuration or a respective payload configuration.

In some cases, the machine learning model is trained to select the selected branch of the plurality of branches of the back-end multi-branch layer based on at least one of a subband pattern, an antenna configuration, a rank, or a payload configuration associated with the input.

A non-transitory computer-readable storage medium can include instructions stored thereon which, when executed by at least one processor, causes the at least one processor to perform any method, process or set of operations disclosed above.

An apparatus for wireless communications can include one or more means for performing operations according to any method, process or set of operations disclosed above.

In some examples, the processes described herein (e.g., process 800, 810 and 820 and/or other process described herein) may be performed by a computing device or apparatus (e.g., a UE or a base station). In another example, the processes 800, 810, 820 may be performed by the UE 104 of FIG. 1. In another example, the processes 800, 810, 820 may be performed by a base station 102 of FIG. 1.

FIG. 8B is a flow chart illustrating an example of a process 811 for wireless communications utilizing reference signals for joint communication and sensing. The process 811 can be performed by a network device or by a component or system (e.g., a chipset) of the network device. The network device may include a UE (e.g., a mobile device such as a mobile phone, a network-connected watch, an extended reality (XR) device such as a virtual reality (VR) device or augmented reality (AR) device, a vehicle or computing device or system of the vehicle, or other device), a base station (e.g., an eNB, gNB, or other base station), a portion of the base station (e.g., a CU, DU, RU, or other portion of the base station), or other device. The operations of the process 811 may be implemented as software components that are executed and run on one or more processors (e.g., processor 910 of FIG. 9 or other processor(s)). Further, the transmission and reception of signals by the wireless communications device in the process 811 may be enabled, for example, by one or more antennas and/or one or more transceivers (e.g., wireless transceiver(s)).

At block 812, the network device (or component thereof) may receive a channel state information (CSI) report configuration comprising at least one of a CSI reporting subband pattern configuration, an antenna configuration, a restriction on possible ranks to be reported, or a payload configuration.

At block 814, the network device (or component thereof) may determine, based on the CSI report configuration, a CSI report dimension associated with output of a machine learning model used by a user equipment to generate a CSI report.

At block 816, the network device (or component thereof) may generate the CSI report using the machine learning model based on the CSI report dimension.

In some aspects, the machine learning model is trained to support at least one of variable antenna configurations, variable subband configurations, variable ranks, or variable payload configurations, the machine learning model comprising a front-end multi-branch layer, a common backbone and a back-end multi-branch layer in which a respective layer of the back-end multi-branch layer is selected based on the CSI report dimension.

In some cases, a respective layer of the front-end multi-branch layer is selected based on at least one of the antenna configuration or a grouping associated with a plurality of antenna configurations.

In some examples, the CSI report dimension associated with the output of the machine learning model scales relative to one or more of a number of configured subbands or a subband span.

In some aspects, the CSI report dimension is determined based on product of a CSI report dimension maximum value and a number of configured subbands or subband span, or determined based on a product of a CSI report dimension maximum value and a ratio of configured number of subbands over the total number of subbands or a ratio of configured subband span over total subband span.

In some cases, the network device (or component thereof) may report at least one of a limited number of front-end branches associated with the machine learning model, a number of antenna configurations supported per branch of the front-end branches, or supported subband patterns.

In some examples, the machine learning model associated to the configured CSI report supports a plurality of CSI report dimension maximum values, or a plurality of CSI report dimension values, for each antenna configuration or subband configuration.

In some aspects, the network device (or component thereof) may receive a payload configuration indicating one of the plurality of CSI report dimension maximum values, or one of the plurality of CSI report dimension values.

In some cases, the plurality of CSI report dimension maximum values or a subset of different CSI report dimension maximum values, or the plurality of CSI report dimension values or a subset of different CSI report dimension values is supported by the machine learning model based on a total number of antenna ports being above or below a threshold value.

In some examples, the machine learning model associated to the configured CSI report supports a first plurality of CSI report dimension maximum values, or a first plurality of CSI report dimension values, for a first set of rank values; and supports a second plurality of CSI report dimension maximum values, or a second plurality of CSI report dimension values, for a second set of rank values.

In some aspects, the first plurality of CSI report dimension maximum values or the first plurality of CSI report dimension values are greater than the second plurality of CSI report dimension maximum values or the second plurality of CSI report dimension values, if the first set of rank values is smaller than the second set of rank values.

In some cases, different antenna configurations or different antenna configuration groups use different branches of a front-end multi-branch layer of the machine learning model for different linear embedding processes.

In some examples, the variable ranks respectively correspond to a respective different layer of a back-end multi-branch layer of the machine learning model.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any layer thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for wireless communication, the apparatus comprising: at least one memory storing instructions to operate a machine learning model trained to support channel state information (CSI) report with at least one of variable antenna configurations, variable subband configurations, variable ranks, or variable payload configurations; and at least one processor coupled to the at least one memory and configured to: obtain an input to a front-end multi-branch layer of the machine learning model; process the input via a selected branch of a plurality of branches in the front-end multi-branch layer to generate a first output; process the first output by a common backbone of the machine learning model to yield a second output; provide the second output to a back-end multi-branch layer of the machine learning model; and process the second output via a selected branch of a plurality of branches of the back-end multi-branch layer to generate a latent message have a dimension.

Aspect 2. The apparatus of claim 1, wherein the back-end multi-branch layer comprises a plurality of linear compression branches, each linear compression branch of the plurality of linear compression branches is configured to compress the second output according to features across frequency and spatial layers.

Aspect 3. The apparatus of claim 1, wherein the dimension of the latent message is implemented by the selected branch of the back-end multi-branch of the machine learning model.

Aspect 4. The apparatus of claim 1, wherein different subband configurations with a same dimension for the latent message use a same compression layer associated with a respective branch of the plurality of branches of the back-end multi-branch layer.

Aspect 5. The apparatus of claim 1, wherein the machine learning model is trained to group multiple antenna configurations into groups that are mapped to a respective branch of the plurality of branches in the front-end multi-branch layer.

Aspect 6. The apparatus of claim 1, wherein the variable antenna configurations are used by a base station to configure the CSI report associated to the machine learning model and wherein the variable subband configurations are the subbands associated with the CSI report.

Aspect 7. The apparatus of claim 1, wherein the dimension of the latent message is determined based on at least one of a subband pattern, an antenna configuration, a rank or a payload configuration associated with the input.

Aspect 8. The apparatus of claim 7, wherein the machine learning model is trained to determine the dimension of the latent message based on the at least one of the subband pattern, the antenna configuration, the rank or the payload configuration associated with the input.

Aspect 9. The apparatus of claim 8, wherein the machine learning model is trained to group multiple subband configurations into groups that are mapped to a respective branch of the plurality of branches in the back-end multi-branch layer

Aspect 10. The apparatus of claim 8, wherein, when the dimension of the latent message is determined based on the subband pattern, the dimension of the latent message scales with a number of configured subbands or scales with a subband span.

Aspect 11. The apparatus of claim 8, wherein, when the dimension of the latent message is determined based on the antenna configuration or the payload configuration the back-end multi-branch layer implements a maximum dimension value for the latent message at a respective compression layer associated with a respective branch of the back-end multi-branch layer.

Aspect 12. The apparatus of claim 8, wherein various antenna configurations that map to a same dimension value for the latent message use a same linear compression layer associate with a respective branch of the back-end multi-branch layer.

Aspect 13. The apparatus of claim 8, wherein, when the dimension of the latent message is determined based on the rank, at least one of a first dimension set is applied to each layer associated with a respective branch of the back-end multi-branch layer for a first rank or a second rank and a second dimension set is applied to each layer associated with a respective branch of the back-end multi-branch layer for a third rank and a fourth rank.

Aspect 14. The apparatus of claim 1, wherein the machine learning model is trained according to at least one of a centralized training approach, a distributed training approach, or a separated training approach.

Aspect 15. The apparatus of claim 14, wherein, when the machine learning model is trained according to the centralized training approach, an entity associated with the apparatus exposes a machine learning model architecture to a training entity and provides an input sample and a ground truth to the training entity, wherein the input sample and the ground truth comprise at least one of variable supported antenna configurations, variable supported subband configurations, variable supported payload configurations, or variable rank hypothesis.

Aspect 16. The apparatus of claim 14, wherein, when the machine learning model is trained according to the distributed training approach, an entity associated with the apparatus that communicates with a network entity, for each iteration of communicating training data, the entity associated with the apparatus provides a ground truth and an activation to the network entity, wherein the ground truth and the activation comprise at least one of variable supported antenna configurations, variable supported subband configurations, variable supported payload configurations or variable rank hypothesis.

Aspect 17. The apparatus of claim 14, wherein, when the machine learning model is trained according to the separated training approach, an entity associated with the apparatus trains an encoder first, and transmits a latent message and a ground truth or a desired decoder output to a network entity, wherein the latent message and the ground truth or the desired decoder output comprise at least one of variable supported antenna configurations, variable supported subband configurations, variable supported payload configurations or variable rank hypothesis.

Aspect 18. The apparatus of claim 1, wherein the apparatus only supports a limited number of branches in the front-end multi-branch layer.

Aspect 19. The apparatus of claim 1, wherein the apparatus only supports certain subband patterns.

Aspect 20. The apparatus of claim 19, wherein the certain subband patterns comprise one or more of a number of subbands, a number of subband spans, and whether the subbands are contiguous or not contiguous.

Aspect 21. The apparatus of claim 1, wherein the front-end multi-branch layer of the machine learning model utilizes antenna setup data in the input to select the selected branch of the plurality of branches of the front-end layer.

Aspect 22. The apparatus of claim 1, wherein the front-end multi-branch layer of the machine learning model transforms the input from a transmission domain to a feature domain.

Aspect 23. The apparatus of claim 22, wherein the common backbone of the machine learning model extracts deep features with positional encoding from the first output and to generate the second output.

Aspect 24. The apparatus of claim 1, wherein the common backbone of the machine learning model comprises a positional embedding layer and a multi-layer machine learning layer.

Aspect 25. The apparatus of claim 1, wherein the back-end multi-branch layer of the machine learning model compresses features of the second output across frequency and layers to generate the latent message having the dimension.

Aspect 26. The apparatus of claim 1, wherein each respective branch of the plurality of branches of the back-end multi-branch layer is associated with one or more of a respective subband configuration, a respective rank, a respective antenna configuration or a respective payload configuration.

Aspect 27. The apparatus of claim 25, wherein the machine learning model is trained to select the selected branch of the plurality of branches of the back-end multi-branch layer based on at least one of a subband pattern, an antenna configuration, a rank, or a payload configuration associated with the input.

Aspect 28. An apparatus for wireless communication, the apparatus comprising: a machine learning model trained to support at least one of variable antenna configurations, variable subband configurations, variable ranks or variable payload configurations; a front-end multi-branch layer of the machine learning model; a common backbone of the machine learning model; a back-end multi-branch layer of the machine learning model; at least one memory storing instructions to operate the machine learning model; and at least one processor coupled to the at least one memory and configured to: receive an input to the front-end multi-branch layer of the machine learning model; process the input via a selected branch of a plurality of branches in the front-end multi-branch layer to generate a first output; process the first output by the common backbone of the machine learning model to yield a second output; provide the second output to the back-end multi-branch layer of the machine learning model; process the second output via a selected branch of a plurality of branches of the back-end multi-branch layer to generate a latent message have a dimension; and transmit the latent message having the dimension to a communication device via a wireless interface.

Aspect 29. An apparatus for wireless communication, the apparatus comprising: at least one memory; and at least one processor coupled to the at least one memory and configured to: receive a channel state information (CSI) report configuration comprising at least one of a CSI reporting subband pattern configuration, an antenna configuration, a restriction on possible ranks to be reported, or a payload configuration; determine, based on the CSI report configuration, a CSI report dimension associated with output of a machine learning model used by a user equipment to generate a CSI report; and generate the CSI report using the machine learning model based on the CSI report dimension.

Aspect 30. The apparatus of claim 29, wherein the machine learning model is trained to support at least one of variable antenna configurations, variable subband configurations, variable ranks, or variable payload configurations, the machine learning model comprising a front-end multi-branch layer, a common backbone and a back-end multi-branch layer in which a respective layer of the back-end multi-branch layer is selected based on the CSI report dimension.

Aspect 31. The apparatus of claim 30, wherein a respective layer of the front-end multi-branch layer is selected based on at least one of the antenna configuration or a grouping associated with a plurality of antenna configurations.

Aspect 32. The apparatus of claim 29, wherein the CSI report dimension associated with the output of the machine learning model scales relative to one or more of a number of configured subbands or a subband span.

Aspect 33. The apparatus of claim 32, wherein the CSI report dimension is determined based on product of a CSI report dimension maximum value and a number of configured subbands or subband span, or determined based on a product of a CSI report dimension maximum value and a ratio of configured number of subbands over the total number of subbands or a ratio of configured subband span over total subband span.

Aspect 34. The apparatus of claim 29, wherein the at least one processor is configured to: report at least one of a limited number of front-end branches associated with the machine learning model, a number of antenna configurations supported per branch of the front-end branches, or supported subband patterns.

Aspect 35. The apparatus of claim 29, wherein the machine learning model associated to the configured CSI report supports a plurality of CSI report dimension maximum values, or a plurality of CSI report dimension values, for each antenna configuration or subband configuration.

Aspect 36. The apparatus of claim 35, wherein the at least one processor is configured to: receive a payload configuration indicating one of the plurality of CSI report dimension maximum values, or one of the plurality of CSI report dimension values.

Aspect 37. The apparatus of claim 36, wherein the plurality of CSI report dimension maximum values or a subset of different CSI report dimension maximum values, or the plurality of CSI report dimension values or a subset of different CSI report dimension values is supported by the machine learning model based on a total number of antenna ports being above or below a threshold value.

Aspect 38. The apparatus of claim 29, wherein the machine learning model associated to the configured CSI report supports a first plurality of CSI report dimension maximum values, or a first plurality of CSI report dimension values, for a first set of rank values; and supports a second plurality of CSI report dimension maximum values, or a second plurality of CSI report dimension values, for a second set of rank values.

Aspect 39. The apparatus of claim 38, wherein the first plurality of CSI report dimension maximum values or the first plurality of CSI report dimension values are greater than the second plurality of CSI report dimension maximum values or the second plurality of CSI report dimension values, if the first set of rank values is smaller than the second set of rank values.

Aspect 40. The apparatus of claim 29, wherein different antenna configurations or different antenna configuration groups use different branches of a front-end multi-branch layer of the machine learning model for different linear embedding processes.

Aspect 41. The apparatus of claim 29, wherein the variable ranks respectively correspond to a respective different layer of a back-end multi-branch layer of the machine learning model.

Aspect 42. An apparatus for wireless communication, the apparatus comprising: at least one memory storing instructions to operate a machine learning model trained to support channel state information (CSI) report with at least one of variable antenna configurations, variable subband configurations, variable ranks, or variable payload configurations; and at least one processor coupled to the at least one memory and configured to: obtain an input to a front-end multi-branch layer of the machine learning model; process the input via a selected branch of a plurality of branches in the front-end multi-branch layer to generate a first output; process the first output by a common backbone of the machine learning model to yield a second output; and generate, based on the second output, a latent message have a dimension.

Aspect 43. An apparatus for wireless communication, the apparatus comprising: at least one memory storing instructions to operate a machine learning model trained to support channel state information (CSI) report with at least one of variable antenna configurations, variable subband configurations, variable ranks, or variable payload configurations; and at least one processor coupled to the at least one memory and configured to: process an input to a common backbone of the machine learning model to yield an output; provide the output to a back-end multi-branch layer of the machine learning model; process the output via a selected branch of a plurality of branches of the back-end multi-branch layer to generate a latent message have a dimension.

Aspect 44. A method of wireless communications, the method including operations according to any of Aspects 1-27.

Aspect 45. A non-transitory computer-readable storage medium comprising instructions stored thereon which, when executed by at least one processor, causes the at least one processor to perform operations according to any of Aspects 1-27.

Aspect 46. An apparatus for wireless communications comprising one or more means for performing operations according to any of Aspects 1-27.

Aspect 44. A method of wireless communications, the method including operations according to Aspect 28 and in some aspects in combination with any of Aspects 2-27.

Aspect 45. A non-transitory computer-readable storage medium comprising instructions stored thereon which, when executed by at least one processor, causes the at least one processor to perform operations according to Aspect 28 and in some aspects in combination with any of Aspects 2-27.

Aspect 46. An apparatus for wireless communications comprising one or more means for performing operations according to Aspect 28 and in some aspects in combination with any of Aspects 2-27.

Aspect 44. A method of wireless communications, the method including operations according to any of Aspects 29-41.

Aspect 45. A non-transitory computer-readable storage medium comprising instructions stored thereon which, when executed by at least one processor, causes the at least one processor to perform operations according to any of Aspects 29-41.

Aspect 46. An apparatus for wireless communications comprising one or more means for performing operations according to any of Aspects 29-41.

Aspect 44. A method of wireless communications, the method including operations according to Aspect 42 and in some aspects in combination with any of Aspects 2-27.

Aspect 45. A non-transitory computer-readable storage medium comprising instructions stored thereon which, when executed by at least one processor, causes the at least one processor to perform operations according to Aspect 42 and in some aspects in combination with any of Aspects 2-27.

Aspect 46. An apparatus for wireless communications comprising one or more means for performing operations according to Aspect 42 and in some aspects in combination with any of Aspects 2-27.

Aspect 44. A method of wireless communications, the method including operations according to Aspect 43 and in some aspects in combination with any of Aspects 2-27.

Aspect 45. A non-transitory computer-readable storage medium comprising instructions stored thereon which, when executed by at least one processor, causes the at least one processor to perform operations according to Aspect 43 and in some aspects in combination with any of Aspects 2-27.

Aspect 46. An apparatus for wireless communications comprising one or more means for performing operations according to Aspect 43 and in some aspects in combination with any of Aspects 2-27.

1. An apparatus for wireless communication, the apparatus comprising:
at least one memory storing instructions to operate a machine learning model trained to support channel state information (CSI) report with at least one of variable antenna configurations, variable subband configurations, variable ranks, or variable payload configurations; and
at least one processor coupled to the at least one memory and configured to:
obtain an input to a front-end multi-branch layer of the machine learning model;
process the input via a selected branch of a plurality of branches in the front-end multi-branch layer to generate a first output;
process the first output by a common backbone of the machine learning model to yield a second output;
provide the second output to a back-end multi-branch layer of the machine learning model; and
process the second output via a selected branch of a plurality of branches of the back-end multi-branch layer to generate a latent message have a dimension.

2. The apparatus of claim 1, wherein the back-end multi-branch layer comprises a plurality of linear compression branches, each linear compression branch of the plurality of linear compression branches is configured to compress the second output according to features across frequency and spatial layers.

3. The apparatus of claim 1, wherein the dimension of the latent message is implemented by the selected branch of the back-end multi-branch layer of the machine learning model.

4. The apparatus of claim 1, wherein different subband configurations with a same dimension for the latent message use a same compression layer associated with a respective branch of the plurality of branches of the back-end multi-branch layer.

5. The apparatus of claim 1, wherein the machine learning model is trained to group multiple antenna configurations into groups that are mapped to a respective branch of the plurality of branches in the front-end multi-branch layer.

6. The apparatus of claim 1, wherein the variable antenna configurations are used by a base station to configure the CSI report associated to the machine learning model and wherein the variable subband configurations are associated with subbands associated with the CSI report.

7. The apparatus of claim 1, wherein the dimension of the latent message is determined based on at least one of a subband pattern, an antenna configuration, a rank, or a payload configuration associated with the input.

8. The apparatus of claim 7, wherein the machine learning model is trained to determine the dimension of the latent message based on at least one of the subband pattern, the antenna configuration, the rank, or the payload configuration associated with the input.

9. The apparatus of claim 8, wherein the machine learning model is trained to group multiple subband configurations into groups that are mapped to a respective branch of the plurality of branches in the back-end multi-branch layer.

10. The apparatus of claim 8, wherein, when the dimension of the latent message is determined based on the subband pattern, the dimension of the latent message scales with a number of configured subbands or scales with a subband span.

11. The apparatus of claim 8, wherein, when the dimension of the latent message is determined based on the antenna configuration or the payload configuration the back-end multi-branch layer implements a maximum dimension value for the latent message at a respective compression layer associated with a respective branch of the back-end multi-branch layer.

12. The apparatus of claim 8, wherein various antenna configurations that map to a same dimension value for the latent message use a same linear compression layer associate with a respective branch of the back-end multi-branch layer.

13. The apparatus of claim 8, wherein, when the dimension of the latent message is determined based on the rank, at least one of a first dimension set is applied to each layer associated with a respective branch of the back-end multi-branch layer for a first rank or a second rank and a second dimension set is applied to each layer associated with a respective branch of the back-end multi-branch layer for a third rank and a fourth rank.

14. The apparatus of claim 1, wherein the machine learning model is trained according to at least one of a centralized training approach, a distributed training approach, or a separated training approach.

15. The apparatus of claim 14, wherein, when the machine learning model is trained according to the centralized training approach, an entity associated with the apparatus exposes a machine learning model architecture to a training entity and provides an input sample and a ground truth to the training entity, wherein the input sample and the ground truth comprise at least one of variable supported antenna configurations, variable supported subband configurations, variable supported payload configurations, or variable rank hypothesis.

16. The apparatus of claim 14, wherein, when the machine learning model is trained according to the distributed training approach, an entity associated with the apparatus that communicates with a network entity, for each iteration of communicating training data, the entity associated with the apparatus provides a ground truth and an activation to the network entity, wherein the ground truth and the activation comprise at least one of variable supported antenna configurations, variable supported subband configurations, variable supported payload configurations, or variable rank hypothesis.

17. The apparatus of claim 14, wherein, when the machine learning model is trained according to the separated training approach, an entity associated with the apparatus trains an encoder first, and transmits a latent message and a ground truth or a desired decoder output to a network entity, wherein the latent message and the ground truth or the desired decoder output comprise at least one of variable supported antenna configurations, variable supported subband configurations, variable supported payload configurations, or variable rank hypothesis.

18. The apparatus of claim 1, wherein the apparatus only supports a limited number of branches in the front-end multi-branch layer.

19. The apparatus of claim 1, wherein the apparatus only supports certain subband patterns.

20. The apparatus of claim 19, wherein the certain subband patterns comprise at least one of a number of subbands, a number of subband spans, or whether subbands of the number of subbands are contiguous or not contiguous.

21. The apparatus of claim 1, wherein the front-end multi-branch layer of the machine learning model utilizes antenna setup data in the input to select the selected branch of the plurality of branches of the front-end multi-branch layer.

22. The apparatus of claim 1, wherein the front-end multi-branch layer of the machine learning model transforms the input from a transmission domain to a feature domain.

23. The apparatus of claim 22, wherein the common backbone of the machine learning model extracts deep features with positional encoding from the first output and to generate the second output.

24. The apparatus of claim 1, wherein the common backbone of the machine learning model comprises a positional embedding layer and a multi-layer machine learning layer.

25. The apparatus of claim 1, wherein the back-end multi-branch layer of the machine learning model compresses features of the second output across frequency and layers to generate the latent message having the dimension.

26. The apparatus of claim 1, wherein each respective branch of the plurality of branches of the back-end multi-branch layer is associated with at least one of a respective subband configuration, a respective rank, a respective antenna configuration, or a respective payload configuration.

27. The apparatus of claim 1, wherein the machine learning model is trained to select the selected branch of the plurality of branches of the back-end multi-branch layer based on at least one of a subband pattern, an antenna configuration, a rank, or a payload configuration associated with the input.

28. (canceled)

29. An apparatus for wireless communication, the apparatus comprising:
at least one memory; and
at least one processor coupled to the at least one memory and configured to:
receive a channel state information (CSI) report configuration comprising at least one of a CSI reporting subband pattern configuration, an antenna configuration, a restriction on possible ranks to be reported, or a payload configuration;
determine, based on the CSI report configuration, a CSI report dimension associated with output of a machine learning model used by a user equipment to generate a CSI report; and
generate the CSI report using the machine learning model based on the CSI report dimension.

30. The apparatus of claim 29, wherein the machine learning model is trained to support at least one of variable antenna configurations, variable subband configurations, variable ranks, or variable payload configurations, the machine learning model comprising a front-end multi-branch layer, a common backbone, and a back-end multi-branch layer in which a respective layer of the back-end multi-branch layer is selected based on the CSI report dimension.

31. (canceled)

32. The apparatus of claim 29, wherein the CSI report dimension associated with the output of the machine learning model scales relative to at least one of a number of configured subbands or a subband span.

33-43. (canceled)
